(19) United States
(12) Patent Application Publication
(10) Pub. No.: US 2026/0064144 A1
(43) Pub. Date: Mar. 5, 2026

(54) VOLTAGE REGULATING DEVICE

(71) Applicant: Winbond Electronics Corp., Taichung City (TW)

(72) Inventor: Ju-An Chiang, Hsinchu (TW)

(73) Assignee: Winbond Electronics Corp., Taichung City (TW)

(21) Appl. No.: 19/171,358

(22) Filed: Apr. 7, 2025

(30) Foreign Application Priority Data
Sep. 3, 2024 (TW) 113133307

(51) Int. Cl. G05F 1/575

(52) U.S. Cl. CPC G05F 1/575

(57) ABSTRACT

A voltage regulating device includes an amplifying circuit, a voltage dividing circuit, and an output stage circuit. The amplifying circuit has a first input end for receiving a reference voltage. An output end of the amplifying circuit provides a first voltage. The voltage dividing circuit divides the first voltage to generate a feedback voltage and provides the feedback voltage to a second input end of the amplifying circuit. The output stage circuit includes a first resistor and a current source coupled in series. The current source is configured to provide a pull-down current flowing toward a reference voltage end, and a coupling end of the first resistor and the current source generates an output voltage.

### CROSS-REFERENCE TO RELATED APPLICATION

This application claims the priority benefit of Taiwan application serial no. 113133307, filed on Sep. 3, 2024. The entirety of the above-mentioned patent application is hereby incorporated by reference herein and made a part of this specification.

### BACKGROUND

### Technical Field

The disclosure relates to a voltage regulating device; particularly, the disclosure relates to a voltage regulating device that may balance circuit area and current consumption.

### Description of Related Art

In a conventional voltage regulating device, a voltage dividing circuit is commonly used to feed back an output voltage to an operational amplifier, allowing the operational amplifier to generate the output voltage by comparing a reference voltage with a feedback voltage generated by the voltage dividing circuit. However, when the output voltage needs to be regulated within a specified range, and if the specified range is overly large and regulating the output voltage requires a relatively high resolution, the voltage dividing circuit needs to be equipped with a large number of circuit elements, leading to excessive use of the circuit area.

### SUMMARY

The disclosure provides a voltage regulating device that may balance design requirements of both current consumption and a circuit area.

According to an embodiment of the disclosure, a voltage regulating device includes an amplifying circuit, a voltage dividing circuit, and an output stage circuit. The amplifying circuit has a first input end for receiving a reference voltage. An output end of the amplifying circuit provides a first voltage. The voltage dividing circuit is coupled between the output end of the amplifying circuit and a reference voltage end. The voltage dividing circuit divides the first voltage to generate a feedback voltage and provides the feedback voltage to a second input end of the amplifying circuit. The output stage circuit is coupled between the output end of the amplifying circuit and the reference voltage end. The output stage circuit includes a first resistor and a current source coupled in series to each other. The current source is configured to provide a pull-down current flowing toward the reference voltage end, and a coupling end between the first resistor and the current source generates an output voltage.

Based on the above, the voltage regulating device provided in one or more embodiments of the disclosure forms a hybrid output architecture by configuring the voltage dividing circuit and the output stage circuit. Thereby, a voltage dividing resolution of the voltage dividing circuit is reduced to decrease the circuit area requirement, and then the output stage circuit is applied to provide the pull-down current to fine-tune the output voltage to compensate for the insufficient resolution of the first voltage in generating the output voltage. As a result, the voltage regulating device provides the user-required output voltage while balancing the design considerations of the circuit area and the current consumption.

### BRIEF DESCRIPTION OF THE DRAWINGS

FIG. 1 is a schematic diagram illustrating a voltage regulating device according to an embodiment of the disclosure.

FIG. 2 is a schematic diagram illustrating a voltage regulating device according to another embodiment of the disclosure.

FIG. 3 is a schematic diagram illustrating an implementation manner of a variable resistor in a voltage regulating device according to an embodiment of the disclosure.

FIG. 4A to FIG. 4B are schematic diagrams respectively illustrating different implementation manner of an output voltage regulating operation of an output stage circuit according to embodiments of the disclosure.

### DESCRIPTION OF THE EMBODIMENTS

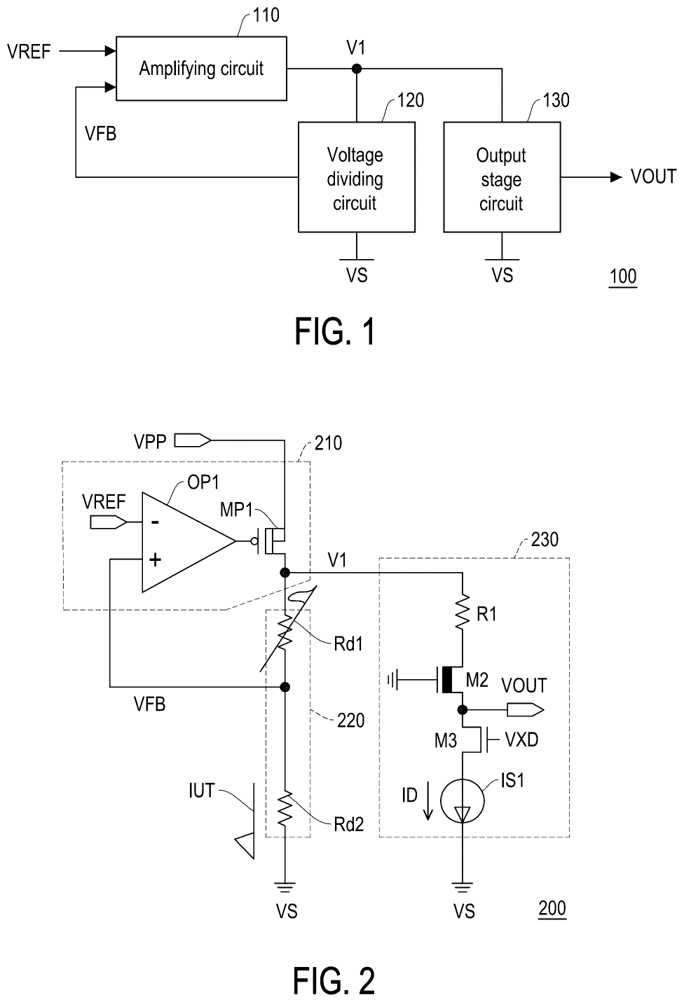

With reference to FIG. 1, a voltage regulating device 100 includes an amplifying circuit 110, a voltage dividing circuit 120, and an output stage circuit 130. The amplifying circuit 110 has a first input end for receiving a reference voltage VREF; the amplifying circuit 110 further has a second input end coupled to the voltage dividing circuit 120 and receives a feedback voltage VFB generated by the voltage dividing circuit 120; an output end of the amplifying circuit 110 provides a first voltage V1.

The voltage dividing circuit 120 is coupled between the output end of the amplifying circuit 110 and a reference voltage end VS, and the voltage dividing circuit 120 receives the first voltage V1 generated by the amplifying circuit 110. The voltage dividing circuit 120 is configured to divide the first voltage V1 to generate the feedback voltage VFB. In this embodiment, the reference voltage end VS may be, for instance, a reference ground end.

The output stage circuit 130 is coupled between the output end of the amplifying circuit 110 and the reference voltage end VS. The output stage circuit 130 includes a resistor and a current source coupled in series to each other. The current source is configured to provide a pull-down current flowing toward the reference voltage end VS and enable the pull-down current to flow through the resistor. One end of the resistor is coupled to the output end of the amplifying circuit 110 for receiving the first voltage V1 and provides a voltage drop according to the pull down current. The output voltage VOUT is generated by further reducing the first voltage V1 based on the voltage drop.

With reference to FIG. 2, a voltage regulating device 200 includes an amplifying circuit 210, a voltage dividing circuit 220, and an output stage circuit 230. The amplifying circuit 210 includes an operational amplifier OP1 and a power transistor MP1. A negative input end of the operational amplifier OP1 receives the reference voltage VREF, and a positive input end of the operational amplifier OP1 is coupled to the voltage dividing circuit 220 to receive the feedback voltage VFB. An output end of the operational amplifier OP1 is coupled to a control end of the power transistor MP1. Besides, a first end of the power transistor MP1 receives a power supply voltage VPP, and a second end of the power transistor MP1 provides the first voltage V1 and is coupled to the voltage dividing circuit 220.

The voltage dividing circuit 220 includes a resistor Rd1 and a resistor Rd2. The resistor Rd1 and the resistor Rd2 are coupled in series in sequence between the second end of the power transistor MP1 and the reference voltage end VS. The resistor Rd1 and the resistor Rd2 are configured to divide the first voltage V1 and generate the feedback voltage VFB at a coupling endpoint between the resistor Rd1 and the resistor Rd2.

In this embodiment, the operational amplifier OP1 may equalize the reference voltage VREF with the feedback voltage VFB. Under the circumstances, the resistor Rd2 may provide a base current IUT flowing toward the reference voltage end VS and enable the base current IUT to flow through the resistor Rd1. Thereby, the first voltage V1 generated at the second end of the power transistor MP1 may be equal to a product of the base current IUT and the sum of the resistance values of the resistors Rd1 and Rd2 (assuming the voltage at the reference ground end VS is 0 volt). Moreover, in this embodiment, the resistor Rd1 may be a variable resistor. Therefore, if the resistance value of the resistor Rd1 is regulated, the voltage value of the first voltage V1 may be further regulated.

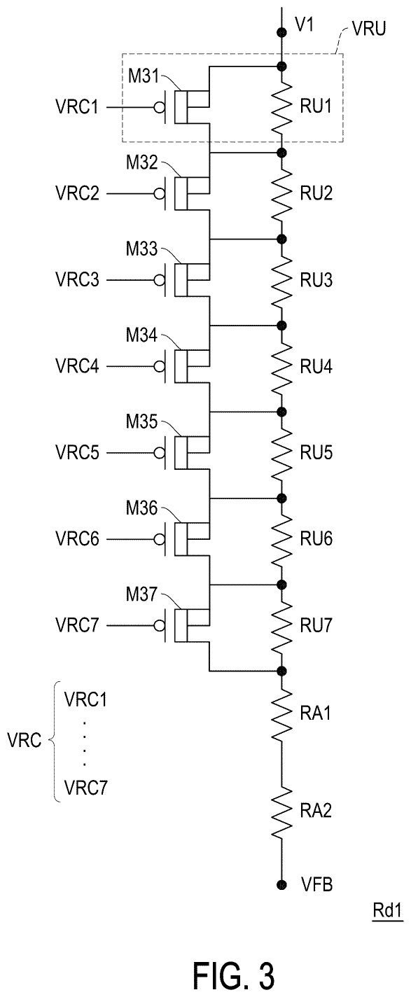

Regarding the implementation details of the resistor Rd1, with reference to FIG. 3, the resistor Rd1 includes a plurality of switches respectively constituted by transistors M31 to M37, a plurality of unit resistors RU1 to RU7, and resistors RA1 and RA2. The switches respectively constituted by the transistors M31 to M37 are coupled in parallel to the unit resistors RU1 to RU7, respectively. Each of the transistors M31 to M37 and the corresponding unit resistors RU1 to RU7 may form a variable resistor unit (such as the transistor M31 and the unit resistor RU1 coupled to form a variable resistor unit VRU), and the variable resistor units VRU in the resistor Rd1 are coupled in series to each other.

Besides, the switches constituted by the transistors M31 to M37 are respectively controlled by a plurality of bits VRC1 to VRC7 of a resistor regulating code VRC to be turned on or turned off. Taking the transistors M31 to M37 as P-type transistors as an example, when the bits VRC1 to VRC7 have a logic value of 0, the corresponding transistors M31 to M37 may be turned on; by contrast, when the bits VRC1 to VRC7 have a logic value of 1, the corresponding transistors M31 to M37 may be turned off.

Taking the transistor M31 and the unit resistor RU1 as an example, when the transistor M31 is turned on, the unit resistor RU1 is bypassed and does not provide any effective resistance value; when the transistor M31 is turned off, the unit resistor RU1 may provide an effective resistance value.

Therefore, in this embodiment, when the number of the bits VRC1 to VRC7 with a logic value of 1 increases (and the number with a logic value of 0 decreases), the number of the unit resistors RU1 contributing to the effective resistance values increases accordingly, thereby raising the resistance value of the resistor Rd1. By contrast, when the number of the bits VRC1 to VRC7 with a logic value of 1 decreases (and the number with a logic value of 0 increases), the number of the unit resistors RU1 contributing to the effective resistance values decreases, thereby lowering the resistance value of the resistor Rd1.

In this embodiment, the resistance values of all the unit resistors RU1 to RU7 may be the same. Certainly, in other embodiments of this disclosure, the resistance value of each unit resistor RU1 may also be different, which should not be construed as a limitation in the disclosure. Besides, the resistors RA1 and RA2 may be coupled in series to the unit resistors RU1 to RU7, and the resistance value of each of the resistors RA1 and RA2 may also be the same as or different from the resistance values of the unit resistors RU1 to RU7, which should not be construed as a limitation in the disclosure.

Certainly, the number of the unit resistors and the corresponding switches in the resistor Rd1 does not have specific limitations. The illustration in FIG. 3 simply serves as an example for explanation and should not be applied to restrict the scope of protection provided in this disclosure.

As shown in FIG. 2, it may be learned from the above explanation that the voltage generating device 200 provided in this embodiment of the disclosure may regulate the resistance value of the resistor Rd1 through regulating each of the bits VRC1 to VRC7 of the resistor regulating code VRC. Through regulating the resistance value of the resistor Rd1, the voltage value of the voltage V1 may be regulated.

It is worth noting that the regulatable resolution of the voltage value of the voltage V1 may correspond to the resolution of the resistance value of the resistor Rd1. However, in order to improve the resolution of the resistance value of the resistor Rd1, it is necessary to configure a sufficient number of the unit resistors and the corresponding switches, which may cause a significant increase in the circuit area. Under these circumstances, the resistor Rd1 is designed to have a moderate resolution according to one or more embodiments of the disclosure. If the resolution of the corresponding output voltage VOUT is insufficient, this issue is resolved by the voltage regulating device 200 provided in this embodiment of the disclosure through the output stage circuit 230.

In this embodiment, the output stage circuit 230 includes the resistor R1, the transistors M2 and M3, and the current source IS1. The resistor R1, the transistors M2 and M3, and the current source IS1 are coupled in series in sequence between the output end of the amplifying circuit 210 (i.e., the output end of the power transistor MP1) and the reference voltage end VS. One end of the resistor R1 receives the first voltage V1, while a coupling end of the transistors M2 and M3 may generate the output voltage VOUT. The current source IS1 is configured to generate the pull-down current ID and enable the pull-down current ID to flow through the resistor R1, so as to discharge the capacitor at the output end of the amplifying circuit 210. By enabling the pull-down current ID to flow through resistor R1, the output stage circuit 230 may generate the output voltage VOUT by lowering the first voltage V1, thereby allowing the output voltage VOUT to reach the expected target voltage value.

Incidentally, in this embodiment, the resistor R1 may be a variable resistor, and the current source IS1 may also be a variable current source. Besides, in this embodiment, the transistor M2 may be a depletion transistor and may be in a normally on state. The transistor M3 may be controlled by a bias voltage VXD.

With reference to FIG. 2 and FIG. 3, here, each of the unit resistors RU1 to RU7, the resistors RA1 and RA2, and the resistor Rd2 is 230 k ohms, for instance, and the base current IUT is 5.2 microamperes, for instance. When the voltage regulating device 200 is about to generate the output voltage VOUT of 8.0V, the bits VRC1 to VRC7 of the resistor regulating code VRC may be set to logic values of 0, 0, 0, 1, 1, 1, and 1, respectively. Thereby, the voltage regulating device 200 may generate the first voltage V1 of 8.4 volt.

Moreover, in the output stage circuit 230, the resistance value of the resistor R1 may be set to 100 k ohms, and the current source IS1 may be configured to provide the pull-down current ID equal to 4 microamperes. As such, the output voltage VOUT may be equal to 8.4-0.4 (equal to 100 k ohms multiplied by 4 microamperes)=8.0 volts.

Note that the output stage circuit 230 may regulate the response speed of the output voltage VOUT by regulating the pull-down current ID of the current source IS1. When the current value of the pull-down current ID is pulled up, the resistance value of the resistor R1 may correspondingly decrease, thereby allowing the output stage circuit 230 to increase the response speed of the output voltage VOUT. Certainly, when the requirement for the response speed of the output voltage VOUT is reduced, the output stage circuit 230 may lower the pull-down current ID of the current source IS1 and correspondingly increase the resistance value of the resistor R1, thereby reducing the current consumption.

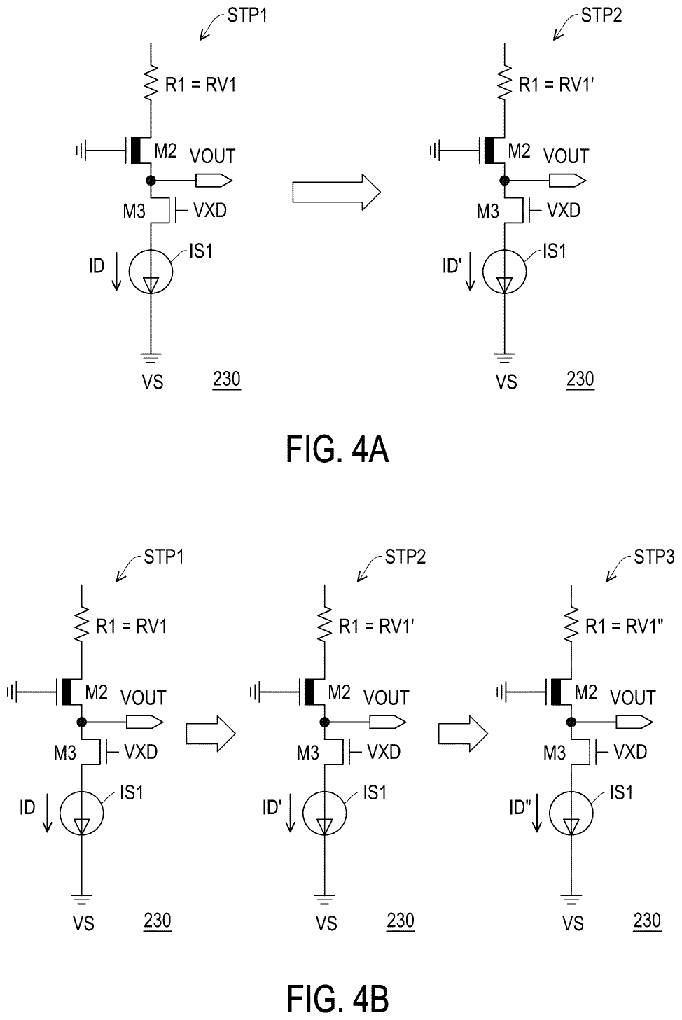

With reference to FIG. 4A to FIG. 4B, in FIG. 4A, the output voltage regulating operation of the output stage circuit 230 may be divided into two stages. In a first stage STP1, the output stage circuit 230 may regulate the resistor R1 to have the first resistance value RV1 and set the current source IS1 to provide the pull-down current ID, where the first resistance value RV1 is, for instance, 50 kilohms, and the pull-down current ID is, for instance, 8 microamperes. The output stage circuit 230 regulates the first voltage V1 to decrease by 0.4 volt to generate the output voltage VOUT through this setting. In a second stage STP2 after the first stage STP1, the output stage circuit 230 may increase the resistance value of the resistor R1 to a second resistance value RV1′ and set the current source IS1 to provide a relatively low pull-down current ID′, where the second resistance value RV1′ is, for instance, 100 kilohms, and the pull-down current ID′ is, for instance, 4 microamperes. Through this setting, the output stage circuit 230 may fix the voltage value of the generated output voltage VOUT.

According to an embodiment of the disclosure, it can be understood from the above description that, in the first stage STP1, the output stage circuit 230 may increase the response speed of the output voltage VOUT by providing a relatively large pull-down current ID. In the second stage STP2, when the output voltage VOUT approaches or reaches the target voltage, the output stage circuit 230 may supply the relatively low pull-down current ID′ to prevent excessive discharge and stabilize the generation of the output voltage VOUT. Moreover, this configuration may reduce the required current consumption.

It is worth mentioning that in the first stage STP1 and the second stage STP2, the product of the first resistance value RV1 and the pull-down current ID may be the same as the product of the second resistance value RV1′ and the pull-down current ID'.

In FIG. 4B, the output voltage regulating operation of the output stage circuit 230 may be divided into multiple stages, e.g., three stages. In the first stage STP1, the output stage circuit 230 may set the resistance value of the resistor R1 to RV1 and enable the current source IS1 to generate the pull down current ID; in the second stage STP2, the output stage circuit 230 may set the resistance value of the resistor R1 to RV1′ and enable the current source IS1 to generate the pull down current ID′; in a third stage STP3, the output stage circuit 230 may set the resistance value of the resistor R1 to RV1″ and enable the current source IS1 to generate a pull down current ID″. Here, the resistance value RV1<the resistance value RV1′<the resistance value RV1″; the pull-down current ID>the pull-down current ID′<the pull-down current ID″, and the product of the resistance value RV1 and the pull-down current ID, the product of the resistance value RV1′ and the pull-down current ID′, and the product of the resistance value RV1″ and the pull-down current ID″ may all be the same.

In other words, the output stage circuit 230 may perform the output voltage regulating operation through a two-stage approach or a multi-stage approach, which may avoid instability of the output voltage VOUT due to excessive discharge and may appropriately increase the response speed of the output voltage VOUT, thereby improving the working efficiency of the voltage regulating device.

To sum up, the voltage generating device provided in one or more embodiments of the disclosure regulates the output voltage through a two-stage approach using the voltage dividing circuit and the output stage circuit. Thereby, the voltage dividing circuit does not need to set a high-resolution voltage dividing ratio, which may effectively reduce the required circuit area. The output stage circuit may adjust the response speed of the output voltage by adjusting the level of the pull down current. Moreover, when the output voltage is in a stable state, the output stage circuit may reduce the pull down current, which may effectively decrease the current consumption and achieve the purpose of energy saving and carbon reduction.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A voltage regulating device, comprising:
an amplifying circuit, having a first input end for receiving a reference voltage, wherein an output end of the amplifying circuit provides a first voltage;
a voltage dividing circuit, coupled between the output end of the amplifying circuit and a reference voltage end, dividing the first voltage to generate a feedback voltage, and providing the feedback voltage to a second input end of the amplifying circuit; and
an output stage circuit, coupled between the output end of the amplifying circuit and the reference voltage end and comprising a first resistor and a current source coupled in series to each other, wherein the current source is configured to provide a pull-down current flowing toward the reference voltage end, and a coupling end between the first resistor and the current source generates an output voltage.

2. The voltage regulating device according to claim 1, wherein the voltage dividing circuit comprises a second resistor and a third resistor, the second resistor and the third resistor are coupled in series in sequence between the output end of the amplifying circuit and the reference voltage end, wherein a base current flows through the third resistor to generate the feedback voltage.

3. The voltage regulating device according to claim 2, wherein the second resistor is a variable resistor and adjusts a resistance value provided by the second resistor according to a resistor regulating code.

4. The voltage regulating device according to claim 3, wherein the second resistor comprises:
a plurality of switches and a plurality of unit resistors, wherein the switches and the unit resistors are respectively coupled in parallel to a plurality of variable resistor units, the variable resistor units are coupled in series to each other, and the switches are respectively controlled by a plurality of bits of the resistor regulating code.

5. The voltage regulating device according to claim 4, wherein the unit resistors have the same resistance value.

6. The voltage regulating device according to claim 1, wherein the first resistor is a variable resistor, and the current source is a variable current source.

7. The voltage regulating device according to claim 6, wherein in a first time interval, the first resistor provides a first resistance value, and the current source generates the pull-down current having a first current value; in a second time interval, the first resistor provides a second resistance value, and the current source generates the pull-down current having a second current value,
wherein the first time interval precedes the second time interval, the first current value is greater than the second current value, and the first resistance value is less than the second resistance value.

8. The voltage regulating device according to claim 7, wherein a product of the first current value and the first resistance value is equal to a product of the second current value and the second resistance value.

9. The voltage regulating device according to claim 8, wherein the product of the first current value and the first resistance value is equal to a voltage difference between the first voltage and the output voltage.

10. The voltage regulating device according to claim 7, wherein in a third time interval, the first resistor provides a third resistance value, and the current source generates the pull-down current having a third current value, wherein the product of the first current value and the first resistance value is equal to a product of the third current value and the third resistance value.

11. The voltage regulating device according to claim 1, wherein the current source provides the pull-down current to discharge a capacitor at the coupling end between the first resistor and the current source.

12. The voltage regulating device according to claim 1, wherein the output stage circuit further comprises:
a first transistor, coupled between the first resistor and the current source; and
a second transistor, coupled between the first transistor and the current source,
wherein the first transistor is in a normally on state, and the second transistor is controlled by a bias voltage.

13. The voltage regulating device according to claim 1, wherein the first transistor is a depletion transistor.

14. The voltage regulating device according to claim 1, wherein the amplifying circuit comprises:
an operational amplifier, having a negative input end for receiving the reference voltage and a positive input end receiving the feedback voltage; and
a power transistor, having a control end coupled to an output end of the operational amplifier, a first end receiving a power supply voltage, and an output end generating the first voltage.
